(19) United States
(12) Patent Application Publication
(10) Pub. No.: US 2026/0177448 A1
(43) Pub. Date: Jun. 25, 2026

(54) Dual Supply Leak Detection System

(71) Applicant: Watts Regulator Co., North Andover, MA (US)

(72) Inventors: Sean Alexander Scruggs, San Marcos, CA (US); Jonathan Naveh, Escondido, CA (US); Jesse Aaron Lafica, Glendale, AZ (US)

(21) Appl. No.: 18/988,137

(22) Filed: Dec. 19, 2024

(51) Int. Cl. G01M 3/28; G01M 3/32

(52) U.S. Cl. CPC G01M 3/2807; G01M 3/3254

(57) ABSTRACT

A dual leak detection system includes two water lines, a first leak detection switch disposed on the first water line, and a second leak detection switch disposed on the second water line. The first leak detection switch includes a first flow sensor and a first valve. Similarly, the second leak detection switch includes a second flow sensor and a second valve. The leak detection system further includes a controller in communication with the first and second leak detection switches. The controller is configured to communicate an alarm state from the first leak detection switch to the second leak detection switch and communicate an alarm state from the second leak detection switch to the first leak detection switch. When in the alarm state, the first leak detection switch is configured to close the first and second valves.

### BACKGROUND OF THE INVENTION

### 1. Field of the Invention

The present invention relates generally to a leak detection system. More specifically, the present invention relates to a dual supply leak detection system.

### 2. Discussion of the Related Art

It is known in the art to provide leak detection systems on incoming fluid supply lines to prevent the continued flow of water into a dwelling when there is a leak. Such a system is designed to prevent water damage in case of a leak. A common leak detection system in the art is a single leak detection switch located on the main fluid supply line prior to a water heater. Upon detection in the single main fluid supply line, the leak detection switch closes the single main fluid supply line. Such a leak detection system is common in dwellings that have their own water heaters and only require the use of a single fluid supply line.

Another common leak detection system includes separate leak detection switches on separate hot and cold supply lines. Each leak detection switch is configured to monitor its own respective hot and cold supply lines. Upon detection of a leak in the hot water supply line, the leak detection switch on the hot water supply line closes the hot water supply line. In turn, the cold water supply continues to flow to the dwelling. Meanwhile, upon detection of a leak in the cold water supply line, the leak detection switch on the cold water supply line closes the cold water supply line. In turn, the hot water supply line continues to flow to the dwelling. Such a leak detection system is common in dwellings independently fed with hot and cold water.

Situations where the cold water supply line is closed but the hot water supply line remains open present increases in risk of injuries associated with hot water. As such, there is a need in the art for a leak detection system that monitors independent hot and cold water lines with leak detection switches configured to communicate with each other to prevent independent closure of the hot and cold supply lines.

### SUMMARY OF THE INVENTION

The present invention is directed to a dual supply leak detection system.

According to an embodiment of the invention, a leak detection system includes a hot water line, a cold water line, a first leak detection switch disposed on the cold water line, and a second leak detection switch disposed on the hot water line. The first leak detection switch includes a first flow sensor and a first valve. Similarly, the second leak detection switch includes a second flow sensor and a second valve. The leak detection system further includes a controller in communication with the first and second leak detection switches. The controller is configured to communicate an alarm state from the first leak detection switch to the second leak detection switch and communicate an alarm state from the second leak detection switch to the first leak detection switch. When in the alarm state, the first leak detection switch is configured to close the first and second valves.

In accordance with another embodiment of the invention, the controller includes a first controller associated with the first detection switch and a second controller associated with the second detection switch. The first controller includes a first radio element configured to communicate with a first detection switch radio element of the first detection switch. Similarly, the second controller includes a second radio element configured to communicate with a second detection switch radio element of the second detection switch.

In accordance with yet another embodiment of the invention, upon detection by the first flow sensor of a leak, the first leak detection switch is put in an alarm state. Conversely, upon detection by the second flow sensor of a leak, the second leak detection switch is put in an alarm state and the second controller sends an alarm signal to the first controller. Upon receipt of the alarm signal by the first controller, the first leak detection switch is put in an alarm state.

In accordance with another embodiment of the invention, the leak detection system includes a power supply configured to supply power to the first detection switch via the second detection switch. The controller may include a radio element configured to communicate with a respective radio element of the first and second leak detection switches. The controller may be in direct communication with the first and second leak detection switches. Alternatively, the controller may be in communication with the second leak detection switch via the first detection switch. An external control device may be in communication with the controller via a wireless connection.

According to another embodiment of the invention, a leak detection method for a system having separate cold and hot water supply lines includes providing a first leak detection switch on the cold water line, the first leak detection switch including a first flow sensor and a first valve, providing a second leak detection switch on the hot water line, the second leak detection switch including a second flow sensor and a second valve, and providing a controller in communication with the first and second leak detection switches. Upon detection by the first flow sensor of a leak, the first leak detection switch is placed in an alarm state and closes the first and second valves.

In accordance with another embodiment of the invention, the method includes providing the controller in direction communication with the first and second leak detection switches. Alternatively, the method may include providing the controller in communication with the second leak detection switch via the first detection switch.

In accordance with yet another embodiment of the invention, providing the controller includes providing a first controller in communication with the first detection switch and a second controller in communication with the second detection switch. Upon detection by the first flow sensor of a leak, the first controller sending an alarm signal to the second controller. On the other hand, upon detection by the second flow sensor of a leak, the second controller is placed in an alarm state and the second controller sends an alarm signal to the first controller. Upon receipt of the alarm signal by the first controller, the first leak detection switch is put in an alarm state and the first and second valves are closed.

According to yet another embodiment of the invention, a leak detection system for a water supply having a cold water supply line and a hot water supply line includes a cold water leak detection switch disposed on the cold water line, a hot water leak detection switch disposed on the hot water line, a power supply configured to supply power to the cold water leak detection switch via the hot water detection switch, and a controller in communication with the cold water and hot water leak detection switches. The cold water leak detection switch includes a cold water flow sensor and a cold water valve. Similarly, the hot water leak detection switch includes a hot water flow sensor and a hot water valve.

The controller is configured to, upon detection of a leak by the hot water sensor, put the hot water leak detection switch in an alarm state, which closes the cold water valve and the hot water valve, and subsequently put the cold water leak detection switch in an alarm state upon detection of a leak by the hot water sensor. On the other hand, upon detection of a leak by the cold water sensor, the controller is configured to put the cold water leak detection switch in an alarm state and subsequently put the hot water leak detection switch in an alarm state, which closes the cold water valve and the hot water valve.

In accordance with another embodiment of the invention, the controller includes a first controller associated with the hot water detection switch and a second controller associated with the cold water detection switch. Upon detection by the hot water flow sensor of a leak, the first controller sends an alarm signal to the second controller, which puts the cold water detection switch in the alarm state. Whereas, upon detection by the cold water flow sensor of a leak, the second controller sends an alarm signal to the first controller, which puts the hot water detection switch in the alarm state.

In accordance with yet another embodiment of the invention, the leak detection system the controller is in direct communication with the cold water and hot water leak detection switches. Alternatively, the controller may be in communication with the hot water leak detection switch via the cold water detection switch.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a block diagram illustrating a dual leak detection system, according to an embodiment of the invention;

FIG. 2 is a block diagram illustrating the controller and power supply configuration of the dual leak detection system of FIG. 1, according to an embodiment of the invention;

FIG. 3 is a flow diagram illustrating the function of the dual leak detection system of FIG. 2;

FIG. 4 is a block diagram illustrating the controller and power supply configuration of the dual leak detection system of FIG. 1, according to another embodiment of the invention;

FIG. 5 is a flow diagram illustrating the function of the dual leak detection system of FIG. 4;

FIG. 6 is a block diagram illustrating the controller and power supply configuration of the dual leak detection system of FIG. 1, according to yet another embodiment of the invention; and

FIG. 7 is a flow diagram illustrating the function of the dual leak detection system of FIG. 6.

In describing the preferred embodiment of the invention, which is illustrated in the drawings, specific terminology will be resorted to for the sake of clarity. However, it is not intended that the invention be limited to the specific terms selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION OF THE INVENTION

The present invention and the various features and advantageous details thereof are explained more fully with reference to the non-limiting embodiments described in detail in the following description.

Throughout this description, various terms denoting direction, such as left and right, front and rear, up and down, top and bottom, and the like may be used. The directions are not intended to be limiting but are used to describe relationships of elements with respect to each other in the accompanying drawings. Unless mutually exclusive, it is contemplated that the elements may be reversed, for example, by turning a component around or upside down without deviating from the scope of the present invention.

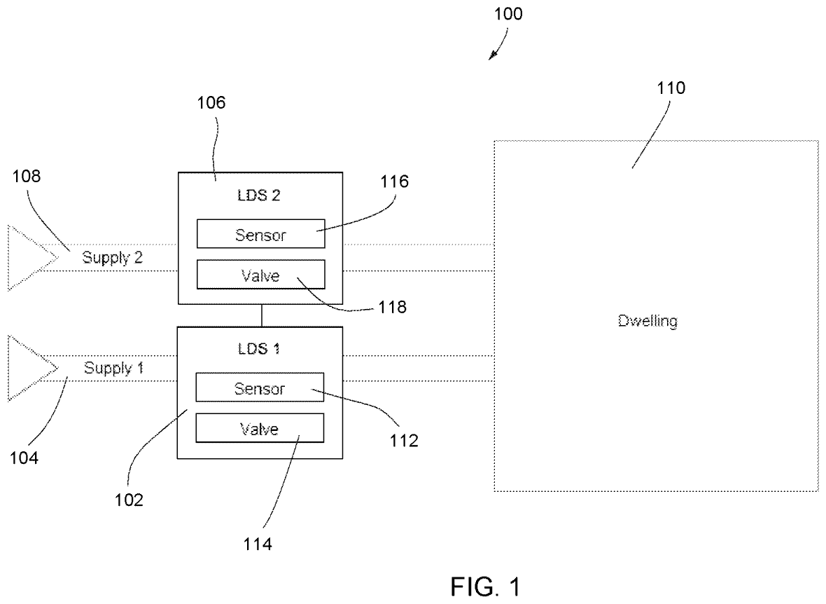

Referring now to FIG. 1, a block diagram of a leak detection system 100 is shown according to an embodiment of the invention. The leak detection system 100 includes a first leak detection switch (LDS 1) 102 disposed on a first fluid supply line 104. In a preferred embodiment of the invention, the first fluid supply line 104 is a hot water supply line 104. In addition, the leak detection system 100 includes a second leak detection switch (LDS 2) 106 disposed on a second fluid supply line 108. In a preferred embodiment of the invention, the second fluid supply line 108 is a cold water supply line 108. Meanwhile, each of the first and second fluid supply lines 104, 108 may be independently fluidically coupled to a dwelling 110, such as a residential dwelling (e.g., apartment, condominium, etc.) or a commercial dwelling (e.g., office, etc.). Preferably, the first and second fluid supply lines 104, 108 separately supply hot and cold water to the dwelling 110.

The first LDS 102 and the second LDS 106 are each leak detection switches including similar components therein. Referring first to the first LDS 102, the first LDS 102 includes a sensor 112 and a valve 114. The sensor 112 is configured to detect flow of a fluid (e.g., hot water) through the first fluid supply line 104. Meanwhile, the valve 114 transitions between an open position and a closed position to either allow or stop flow of the fluid through the first fluid supply line 104. Similarly, the second LDS 106 includes a sensor 116 and a valve 118. The sensor 116 is configured to detect flow of a fluid (e.g., cold water) through the second fluid supply line 108. Like the valve 114, the valve 118 transitions between an open position and a closed position to either allow or stop flow of the fluid through the second fluid supply line 108. The interaction between the sensors 112, 116 and valves 114, 118 of the first and second LDS 102, 106 will be described in further detail below in a variety of embodiments of the invention.

In varying embodiments of the invention, each sensor 112, 116 may separately or together be in the form of variety of flow meter sensors. Examples include, but are not limited to, a positive displacement flow meter, an ultrasonic flow meter, an electromagnetic flow meter, a turbine flow meter, etc.

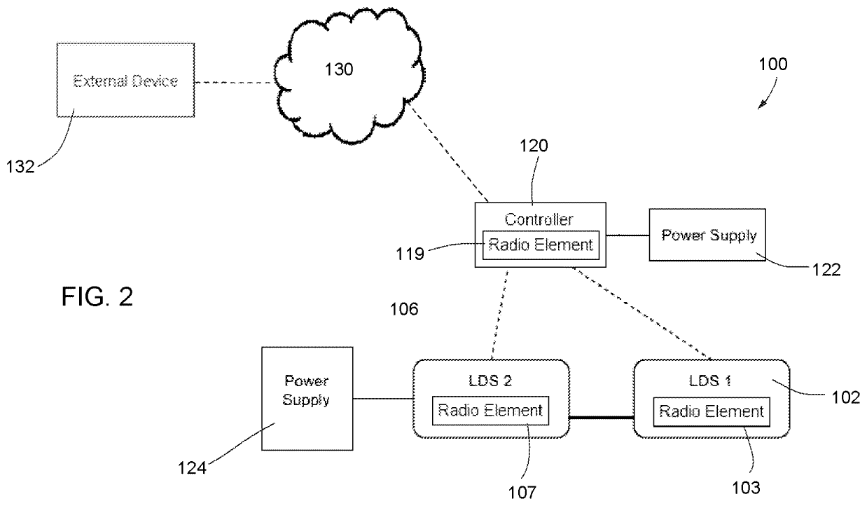

Next, FIG. 2 illustrates a block diagram of a leak detection system 100 according to another embodiment of the invention. As shown in FIG. 1, first LDS 102 is coupled to the first supply line 104, which is preferably a hot water supply line. Meanwhile, second LDS 106 is coupled to the second supply line 108, which is preferably a cold water supply line. In the embodiment of FIG. 2, a controller 120 is communicatively coupled to both the first LDS 102 and the second LDS 106. Preferably, the controller 120 is communicatively coupled to the first and second LDS 102, 106 via a wireless communication connection. As shown in FIG. 2, the controller 120 includes a radio element 119 in wireless communication with a radio element 103 of the first LDS 102 and a radio element 107 of the second LDS 106.

The controller 120 is powered by a first power supply 122. Similarly, the first and second LDS 102, 106 are powered by a second power supply 124. In the representative embodiment of the invention, the first and second power supplies 122, 124 are separate power supplies, however, in alternative embodiments of the invention, the power supplies 122, 124 may be the same power supply. As shown in FIG. 2, the second power supply 124 provides power directly to the second LDS 106 and indirectly to the first LDS 102 via the second LDS 106. By passing power to the first LDS 102 through the second LDS 106, it is ensured that the second LDS 106 has power if the first LDS 102 has power. As a result, the first valve 114 can only close if the second valve 118 is able to close, which ensures that both valves 114, 118 are closed upon detection of a leak by either the first or second LDS 102, 106.

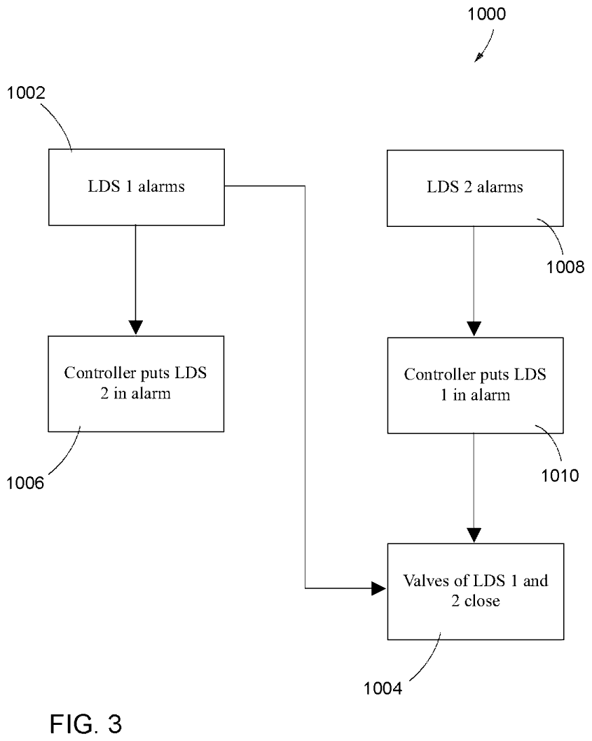

FIG. 3 is a flow diagram illustrating the function 1000 of the leak detection system 100 with the controller 120 and power supply 122, 124 arrangement shown in FIG. 2. In an instance where the sensor 112 of the first LDS 102 detects a leak, the first LDS 102 is put into alarm (block 1002). As a result, the valves 114, 118 of both the first and second LDS 102, 106 are closed to prevent flow of fluid through the first and second supply lines 104, 108 (block 1004). In addition, the controller 120 reads that the first LDS 102 is in alarm and puts the second LDS 106 into alarm (block 1006). In an instance where the sensor 116 of the second LDS 106 detects a leak, the second LDS 106 is put into alarm (1008). The controller 120 reads that the second LDS 106 is in an alarm and puts the first LDS 102 into alarm (block 1010). As a result, the valves 114, 118 of both the first and second LDS 102, 106 are closed to prevent flow of fluid through the first and second supply lines 104, 108 (block 1004).

In each instance, it is the placing of the first LDS 102 into alarm that leads to closure of both valves 114, 118 to prevent flow of fluid through the first and second supply lines 104, 108. As discussed above, preferably the first and second supply lines 104, 108 are hot and cold water supply lines, respectively. As a result, any determination of a leak on either the hot water supply line 104 or the cold water supply line 108 results in the closure of valves 114, 118 on both lines 104, 108. As a result, the leak detection system 100 results in prevention of a single supply line continuing to feed the dwelling 110 with only hot or cold water.

In an instance where the controller 120 is not receiving power from the first power supply 122, the controller 120 is unable to read the alarm state of the first LDS 102 and put the second LDS 106 into alarm. However, the alarm state of the first LDS 102 automatically causes closure of the first and second valves 114, 118. As a result, a leak detection on the first, hot water supply line 104 results in closure of both valves 114, 118 and stoppage of hot and cold water supply to the dwelling 110 regardless of the power state of the controller 120.

Alternatively, when the controller 120 is not receiving power from the first power supply 122, the controller 120 is unable to read the alarm state of the second LDS 106 and put the first LDS 102 into alarm. As a result, a leak detection on the second, cold water supply line 108 would put the second LDS 106 in an alarm state which would not be able to be communicated to the first LDS 102. In turn, neither valve 114, 118 would close. Such a configuration prevents closure of the cold water supply line 108 without closure of the hot water supply 104 and, therefore, prevents supply of only hot water to the dwelling 110.

FIG. 2 further illustrates the connection of an external device 132 to the controller 120 via a wireless connection. In the representative embodiment of the invention, the wireless connection may be via the Internet 130. The external device 132 is contemplated as being any external user device, such as, but not limited to, a phone, tablet, laptop, or other computer device. In turn, an alarm state of the first and second LDS 102, 106 may be communicated to the external device 132 by the controller 120 to notify a user of the status of the first and second LDS 102, 106 and the closure of the valves 114, 118.

In alternative embodiments of the invention, the controller 120 may be internally located within one or both of the first and second LDS 102, 106. In other embodiments of the invention, the controller 102 may be internally located within the external device 132 and communicate with one or both of the first and second LDS 102, 106 via wireless communication through the Internet 130. In yet other embodiments of the invention, the controller 120 may be in wireless communication with one or both of the first and second LDS 102, 106 via the Internet 130.

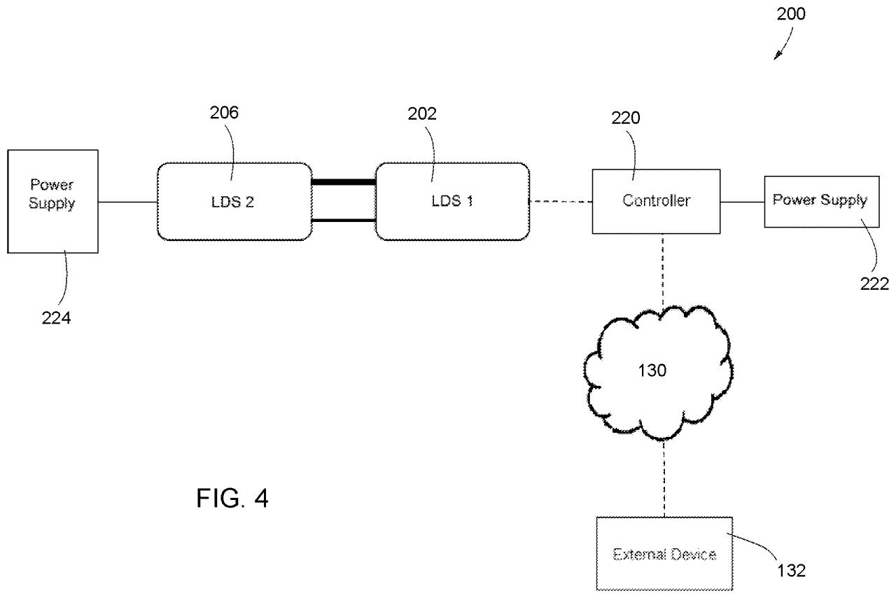

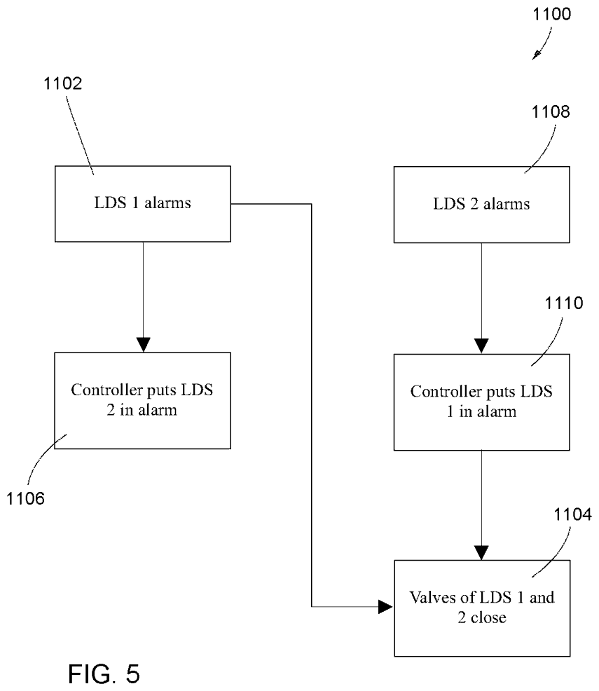

Now referring to FIG. 4, a block diagram of a leak detection system 200 is shown according to another embodiment of the invention. In leak detection system 200, the first LDS 202 is equivalent to the first LDS 102 shown in FIG. 1 and is coupled to the first supply line 104, which is preferably a hot water supply line. Meanwhile, the second LDS 206 is equivalent to the second LDS 106 shown in FIG. 1 and is coupled to the second supply line 108, which is preferably a cold water supply line. In turn, the valves and sensors of the first and second LDS 202, 206 will be referred to as valves 114, 118 and sensors 112, 116 in the description of the embodiment of FIGS. 4 and 5.

A controller 220 is communicatively coupled to the first and second LDS 202, 206. Preferably, the controller 220 is in direct communication with the first LDS 202 and in communication with the second LDS 206 via the first LDS 202. More preferably, the controller 220 is communicatively coupled to the first and second LDS 202, 206 via a wired communication. In alternative embodiments using wireless communication, it is contemplated that the controller 220 and the first and second LDS 202, 206 may include radio elements such as those seen in FIG. 2. The controller 220 is powered by a first power supply 222.

Similarly, the first and second LDS 202, 206 are powered by a second power supply 224. In the representative embodiment of the invention, the first and second power supplies 222, 224 are separate power supplies, however, in varying embodiments of the invention, the power supplies 222, 224 may be the same power supply. As shown in FIG. 4, the second power supply 224 provides power directly to the second LDS 206 while also providing power to the first LDS 202 via the second LDS 206. By passing power to the first LDS 202 through the second LDS 206, it is ensured that the second LDS 206 has power if the first LDS 202 has power. As a result, the first valve 114 can only close if the second valve 118 is able to close, which ensures that both valves 114, 118 upon detection of a leak by either the first or second LDS 202, 206.

FIG. 5 illustrates the function 1100 of the leak detection system 200 shown in FIG. 4. When the sensor 112 of the first LDS 202 detects a leak, the first LDS 202 is put into alarm (block 1102). As a result, the valves 114, 118 of both the first and second LDS 202, 206 are closed to prevent flow of fluid through the first and second supply lines 104, 108 (block 1104). In addition, the controller 220 reads that the first LDS 202 is in alarm and puts the second LDS 206 into alarm (block 1106). Conversely, when the sensor 116 of the second LDS 206 detects a leak, the second LDS 206 is put into alarm (1108). The controller 220 reads that the second LDS 206 is in an alarm and puts the first LDS 202 into alarm (block 1110). As a result, the valves 114, 118 of both the first and second LDS 202, 206 are closed to prevent flow of fluid through the first and second supply lines 104, 108 (block 1104).

In each instance, it is the placing of the first LDS 202 into alarm that leads to closure of both valves 114, 118 to prevent flow of fluid through the first and second supply lines 104, 108. As discussed above, preferably the first and second supply lines 104, 108 are hot and cold water supply lines, respectively. As a result, any determination of a leak on either the hot water supply line 104 or the cold water supply line 108 results in the closure of valves 114, 118 on both lines 104, 108. As a result, the leak detection system 200 results in prevention of a single supply line continuing to feed the dwelling 110 with only hot or cold water.

In an instance where the controller 220 is not receiving power from the first power supply 222, the controller 220 is unable to read the alarm state of the first LDS 202 and put the second LDS 206 into alarm. However, the alarm state of the first LDS 202 automatically causes closure of the first and second valves 114, 118. As a result, a leak detection on the first, hot water supply line 104 results in closure of both valves 114, 118 and stoppage of hot and cold water supply to the dwelling 110 regardless of the power state of the controller 120.

Alternatively, when the controller 220 is not receiving power from the first power supply 222, the controller 220 is unable to read the alarm state of the second LDS 206 and put the first LDS 202 into alarm. As a result, a leak detection on the second, cold water supply line 108 would put the second LDS 206 in an alarm state which would not be able to be communicated to the first LDS 202. In turn, neither valve 114, 118 would close. Such a configuration prevents closure of the cold water supply line 108 without closure of the hot water supply 104 and, therefore, prevents supply of only hot water to the dwelling 110.

Similar to FIG. 2, FIG. 4 further illustrates the connection of an external device 132 to the controller 220 via a wireless connection. In the representative embodiment of the invention, the wireless connection may be via the Internet 130. The external device 132 is contemplated as being any external user device, such as, but not limited to, a phone, tablet, laptop, or other computer device. In turn, an alarm state of the first and second LDS 202, 206 may be communicated to the external device 132 by the controller 220 to notify a user of the status of the first and second LDS 202, 206 and the closure of the valves 114, 118.

In alternative embodiments of the invention, the controller 220 may be internally located within the first LDS 202. In other embodiments of the invention, the controller 220 may be internally located within the external device 132 and communicate with the first LDS 202 and the second LDS 206 (via the first LDS 202) via wireless communication through the Internet 130. In yet other embodiments of the invention, the controller 220 may be in wireless communication with the first LDS 202 and the second LDS 206 (via the first LDS 202) via the Internet 130.

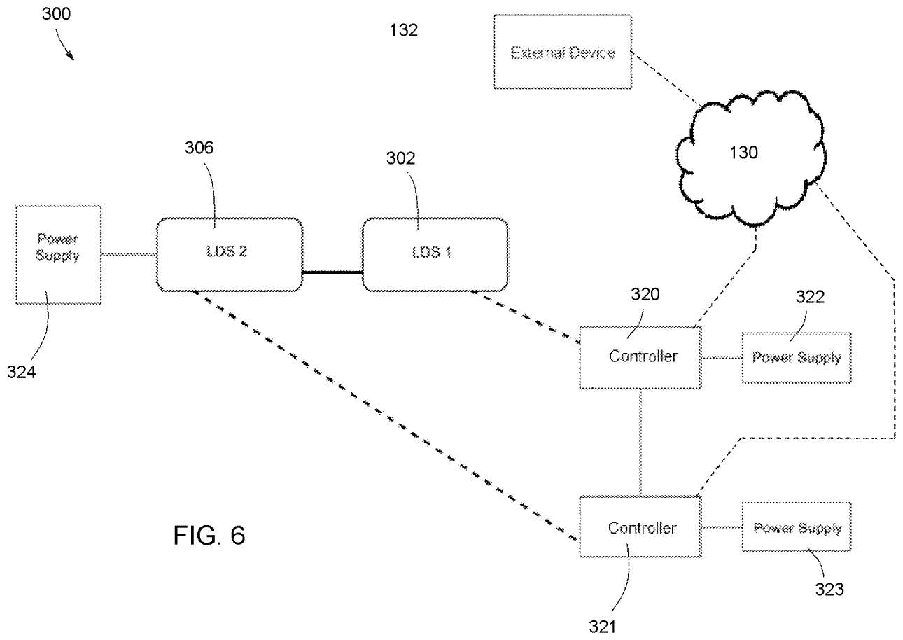

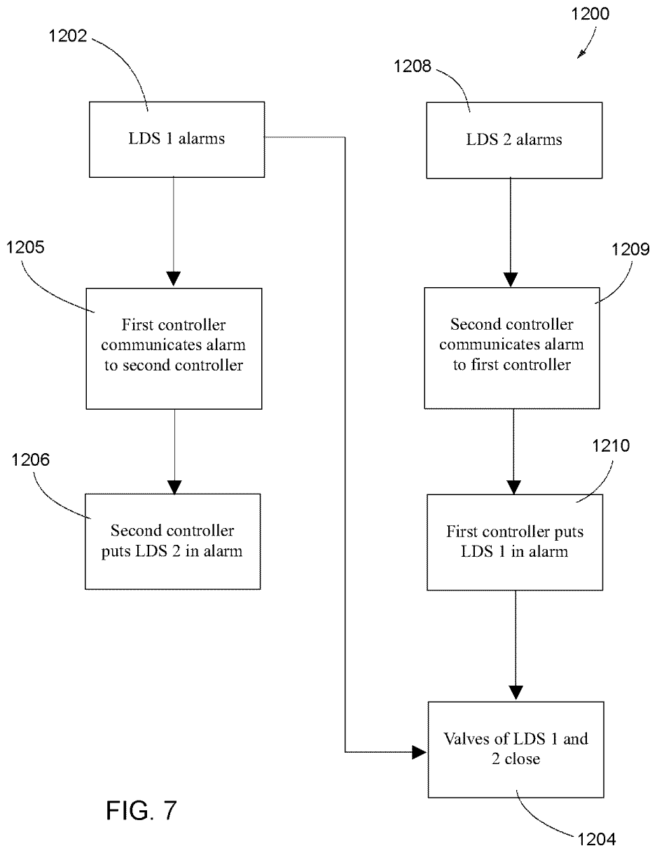

Now referring to FIG. 6, a block diagram of a leak detection system 300 is shown according to yet another embodiment of the invention. In leak detection system 300, the first LDS 302 is equivalent to the first LDS 102 shown in FIG. 1 and is coupled to the first supply line 104, which is preferably a hot water supply line. Meanwhile, the second LDS 306 is equivalent to the second LDS 106 shown in FIG. 1 and is coupled to the second supply line 108, which is preferably a cold water supply line. In turn, the valves and sensors of the first and second LDS 302, 306 will be referred to as valves 114, 118 and sensors 112, 116 in the description of the embodiment of FIGS. 6 and 7.

A first controller 320 is communicatively coupled to the first LDS 302 and a second controller 321 is communicatively coupled to the second LDS 306. In turn, the first and second controllers 320, 321 are communicatively coupled to each other. The communication connections between the first and second controllers 320, 321 and between the first and second controllers 320, 321 and their respective first and second LDS 302, 306 may be any combination of wireless and wired connections in varying embodiments of the invention. In embodiments using wireless communication, it is contemplated that the controller 220 and the first and second LDS 202, 206 may include radio elements such as those seen in FIG. 2. The first controller 320 is powered by a first power supply 322, while the second controller 321 is powered by a second power supply 323. In alternative embodiments of the invention, a single power supply may be used to power the first and second controllers 320, 321.

Meanwhile, the first and second LDS 302, 306 are powered by a third power supply 324. In the representative embodiment of the invention, the power supplies 322, 323, 324 are separate power supplies, however, in varying embodiments of the invention, the power supplies 322, 323, 324 may be the same power supply. In the representative embodiment of the invention, the third power supply 324 provides power directly to the second LDS 306 while also providing power to the first LDS 302 via the second LDS 306. By passing power to the first LDS 302 through the second LDS 306, it is ensured that the second LDS 306 has power if the first LDS 302 has power. In turn, the first valve 114 can only close if the second valve 118 is able to close, which ensures that both valves 114, 118 upon detection of a leak by either the first or second LDS 302, 306.

FIG. 7 illustrates the function 1200 of the leak detection system 300 shown in FIG. 6. When the sensor 112 of the first LDS 302 detects a leak, the first LDS 320 is put into alarm (block 1202). As a result, the valves 114, 118 of both the first and second LDS 202, 206 are closed to prevent flow of fluid through the first and second supply lines 104, 108 (block 1204). In addition, the first controller 320 reads that the first LDS 302 is in alarm and sends an alarm signal to the second controller 321 (block 1205). Upon receipt of the alarm signal, the second controller 321 puts the second LDS 206 into alarm (block 1206). Conversely, when the sensor 116 of the second LDS 306 detects a leak, the second LDS 306 is put into alarm (1208). The second controller 321 reads that the second LDS 306 is in alarm and sends an alarm signal to the first controller 320 (block 1209). Upon receipt of the alarm signal, the first controller 320 puts the first LDS 302 into alarm (block 1210). As a result, the valves 114, 118 of both the first and second LDS 302, 306 are closed to prevent flow of fluid through the first and second supply lines 104, 108 (block 1204).

In each instance, it is the placing of the first LDS 302 into alarm that leads to closure of both valves 114, 118 to prevent flow of fluid through the first and second supply lines 104, 108. As discussed above, preferably the first and second supply lines 104, 108 are hot and cold water supply lines, respectively. As a result, any determination of a leak on either the hot water supply line 104 or the cold water supply line 108 results in the closure of valves 114, 118 on both lines 104, 108. As a result, the leak detection system 300 results in prevention of a single supply line continuing to feed the dwelling 110 with only hot or cold water.

In an instance where the first controller 320 is not receiving power from the first power supply 322, the first controller 320 is unable to read the alarm state of the first LDS 302 and send an alarm signal to the second controller 321 to put the second LDS 306 into alarm. However, the alarm state of the first LDS 302 automatically causes closure of the first and second valves 114, 118. As a result, a leak detection on the first, hot water supply line 104 results in closure of both valves 114, 118 and stoppage of hot and cold water supply to the dwelling 110 regardless of the power state of the first controller 320.

Alternatively, when the second controller 321 is not receiving power from the second power supply 323, the second controller 321 is unable to read the alarm state of the second LDS 306 send an alarm signal to the first controller 320 to put the first LDS 320 into alarm. As a result, a leak detection on the second, cold water supply line 108 would put the second LDS 306 in an alarm state which would not be able to be communicated to the first LDS 302. In turn, neither valve 114, 118 would close. Such a configuration prevents closure of the cold water supply line 108 without closure of the hot water supply 104 and, therefore, prevents supply of only hot water to the dwelling 110.

Further yet, if the communication connection between the first and second controllers 320, 321 is broken, the first controller 320 and the second controller 321 are unable to send alarm signals to each other. As a result, if the first LDS 302 is in the alarm state, all of the valves 114, 118 are closed even though the first controller 320 is unable to communicate the alarm signal to the second controller 321. In other words, a leak detection on the first, hot water supply line 104 results in closure of the valves 114, 118 regardless of communication between the controllers 320, 321. On the other hand, if the second LDS 306 is in the alarm state, the second controller 321 is unable to communicate the alarm signal to the first controller 320. As a result, neither valve 114, 118 would close. Such a configuration prevents closure of the cold water supply line 108 without closure of the hot water supply 104 and, therefore, prevents supply of only hot water to the dwelling 110.

Like FIGS. 2 and 4, FIG. 6 further illustrates the connection of an external device 132 to the first and second controllers 320, 321 via a wireless connection. In the representative embodiment of the invention, the wireless connection may be via the Internet 130. The external device 132 is contemplated as being any external user device, such as, but not limited to, a phone, tablet, laptop, or other computer device. In turn, an alarm state of the first and second LDS 302, 306 may be communicated to the external device 132 by the first and second controllers 320, 321 to notify a user of the status of the first and second LDS 302, 306 and the closure of the valves 114, 118.

In alternative embodiments of the invention, the first controller 320 may be internally located within the first LDS 302 and the second controller may be internally located within the second LDS 306. In other embodiments of the invention, the first and second controllers 320, 321 may be internally located within the external device 132 and communicate with the first LDS 302 and the second LDS 306 via wireless communication through the Internet 130. In yet other embodiments of the invention, the first and second controllers 320, 321 may be in wireless communication with the first LDS 302 and the second LDS 306 via the Internet 130.

Referring again to FIG. 1, while the representative embodiment of the invention illustrates a first sensor 112 on the first supply line 104 and a second sensor 116 on the second supply line 108, other embodiments of the invention may include multiple first sensors 112 on the first supply line 104 and multiple second sensors 116 on the second supply line 108 to sense a change in flow along a substantial length of the first and second supply lines 104, 108. Further yet, the first and second supply lines 104, 108 may include return lines from the dwelling 110 to create a closed loop system return. In such embodiments of the invention, additional first sensors 112 and second sensors 116 may be installed on the return lines associated with the first supply line 104 and the second supply line 106 to sense a change in flow along the return lines.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

Further, the individual components discussed above are not limited to any material. That is, each component may independently be made from any material such as, but not limited to, metal, plastic, wood, etc.

It is intended that the appended claims cover all such additions, modifications and rearrangements. Expedient embodiments of the present invention are differentiated by the appended claims.

1. A leak detection system comprising:
a) a first water line and a second water line;
b) a first leak detection switch disposed on the first water line, the first leak detection switch including:
a first flow sensor; and
a first valve;
c) a second leak detection switch disposed on the second water line, the second leak detection switch including:
a second flow sensor; and
a second valve; and
d) a controller in communication with the first and second leak detection switches, the controller configured to:
communicate an alarm state from the first leak detection switch to the second leak detection switch; and
communicate an alarm state from the second leak detection switch to the first leak detection switch;
when in the alarm state, the first leak detection switch is configured to close the first and second valves.

2. The leak detection system of claim 1, wherein the controller includes a first controller associated with the first detection switch and a second controller associated with the second detection switch.

3. The leak detection system of claim 2, wherein upon detection by the first flow sensor of a leak, the first leak detection switch is put in an alarm state.

4. The leak detection system of claim 2, wherein upon detection by the second flow sensor of a leak, the second leak detection switch is put in an alarm state and the second controller sends an alarm signal to the first controller; and
upon receipt of the alarm signal by the first controller, the first leak detection switch is put in an alarm state.

5. The leak detection system of claim 2, further comprising a first radio element included in the first controller and configured to communicate with a first detection switch radio element of the first detection switch, and a second radio element included in the second controller and configured to communicate with a second detection switch radio element of the second detection switch.

6. The leak detection system of claim 1, further comprising a power supply configured to supply power to the first detection switch via the second detection switch.

7. The leak detection system of claim 1, wherein the controller is in direct communication with the first and second leak detection switches.

8. The leak detection system of claim 1, wherein the controller is in communication with the second leak detection switch via the first detection switch.

9. The leak detection system of claim 1, further comprising an external device in communication with the controller via a wireless connection.

10. The leak detection system of claim 1, further comprising a radio element of the controller configured to communicate with a respective radio element of the first and second leak detection switches.

11. A leak detection method for a system having separate first and second water supply lines, the method comprising:
providing a first leak detection switch on the first water line, the first leak detection switch including a first flow sensor and a first valve;
providing a second leak detection switch on the second water line, the second leak detection switch including a second flow sensor and a second valve;
providing a controller in communication with the first and second leak detection switches; and
upon detection by the first flow sensor of a leak, the first leak detection switch closes the first and second valves.

12. The method of claim 11 wherein, upon detection by the first flow sensor of a leak, the first leak detection switch is placed in an alarm state.

13. The method of claim 11, further comprising providing the controller in direct communication with the first and second leak detection switches.

14. The method of claim 11, further comprising providing the controller in communication with the second leak detection switch via the first detection switch.

15. The method of claim 11, providing the controller comprises providing a first controller in communication with the first detection switch and a second controller in communication with the second detection switch.

16. The leak detection system of claim 15, further comprising, upon detection by the first flow sensor of a leak, the first controller sending an alarm signal to the second controller;
upon detection by the second flow sensor of a leak, the second controller is placed in an alarm state and the second controller sends an alarm signal to the first controller; and
upon receipt of the alarm signal by the first controller, the first leak detection switch is put in an alarm state and the first and second valves are closed.

17. A leak detection system for a water supply including a cold water supply line and a hot water supply line, the leak detection system comprising:
a cold water leak detection switch disposed on the cold water line, the cold water leak detection switch including a cold water flow sensor and a cold water valve;
a hot water leak detection switch disposed on the hot water line, the hot water leak detection switch including a hot water flow sensor and a hot water valve;
a power supply configured to supply power to the cold water leak detection switch via the hot water detection switch; and
a controller in communication with the cold water and hot water leak detection switches, the controller configured to:
upon detection of a leak by the hot water flow sensor, put the hot water leak detection switch in an alarm state, which closes the cold water valve and the hot water valve, and subsequently put the cold water leak detection switch in an alarm state upon detection of a leak by the hot water sensor; and
upon detection of a leak by the cold water flow sensor, close the cold water valve and the hot water valve.

18. The leak detection system of claim 17, wherein the controller comprises a first controller associated with the hot water detection switch and a second controller associated with the cold water detection switch;
wherein upon detection by the hot water flow sensor of a leak, the first controller sends an alarm signal to the second controller, which puts the cold water detection switch in an alarm state;
wherein upon detection by the cold water flow sensor of a leak, the second controller sends an alarm signal to the first controller, which puts the hot water detection switch in an alarm state.

19. The leak detection system of claim 17, wherein the controller is in direct communication with the cold water and hot water leak detection switches.

20. The leak detection system of claim 17, wherein the controller is in communication with the hot water leak detection switch via the cold water detection switch.
